(19) United States
(12) Patent Application Publication
(10) Pub. No.: US 2012/0001459 A1
(43) Pub. Date: Jan. 5, 2012

(54) Retractable Car Umbrella

(76) Inventor: Mario Luis Nunez, Miami, FL (US)

(21) Appl. No.: 12/766,078

(22) Filed: Jul. 1, 2010

(51) Int. Cl. B60J 7/00

(52) U.S. Cl. 296/219

(57) ABSTRACT

A retractable canvas roof for automobiles meant to provide cover from heavy rain when entering or exiting said automobile. The disclosure also comprising of a sensor to detect heavy rain. A locking mechanism to engage the roof and deploy it when the door is opened and a retracting mechanism to pull on the canvas roof when the door is being closed.

### FIELD OF THE INVENTION

The disclosure generally relates to a car umbrella. More particularly to a retractable canvas roof that will shield passengers from heavy rain.

### BACKGROUND OF THE INVENTION

It is a common occurrence for people to get uncomfortably wet under heavy rain when entering or exiting an automobile even when carrying a conventional umbrella. Accordingly a retractable canvas roof deployed automatically in accordance to weather conditions from the main body of the car to the opened door is necessary.

### SUMMARY OF THE INVENTION

The disclosure is generally directed to a retractable canvas roof which will shield passengers from heavy rain. An illustrative embodiment of the retractable car umbrella includes a canvas roof, a sensor to detect heavy rain and engaging a locking mechanism, and a retracting mechanism to roll in the canvas roof while the door is being closed.

### BRIEF DESCRIPTION OF THE DRAWINGS

The description will now be made, by way of example, with reference to the accompanying drawings, in which:

FIG. 1 is a perspective view of a section of a cylindrical housing structure of the retracting mechanism, more particularly illustrating the retracting mechanism inside.

FIG. 2 is a perspective view of a car with its door opened and the retractable canvas roof expanding from the main body of the car to the opened door. There are also detail views of the rod at the edge of the retractable canvas roof and the locking mechanism.

FIG. 3 is another perspective view of the edge of the canvas roof, more particularly illustrating the rod to which the locking mechanism will attach.

FIG. 4 is a schematic representation of the sensor to detect heavy rain, more particularly illustrating an inverted bell-like structure to concentrate sound waves, a circuit with a variable capacitor, another circuit with a transistor and an electromagnet, a sliding contacts plate and lastly a permanent magnet.

### DETAILED DESCRIPTIONS OF DRAWINGS

The following detailed description is merely exemplary in nature and is not intended to limit the described embodiment or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to implement the disclosure and are not intended to limit the scope of the claims. Furthermore, there is no intention to be bound by any expressed or implied theory presented in the preceding technical field, background, brief summary or the following detailed description.

Referring to the drawings, an illustrative embodiment of the car retractable umbrella system, hereinafter system, is generally indicated by reference numeral.

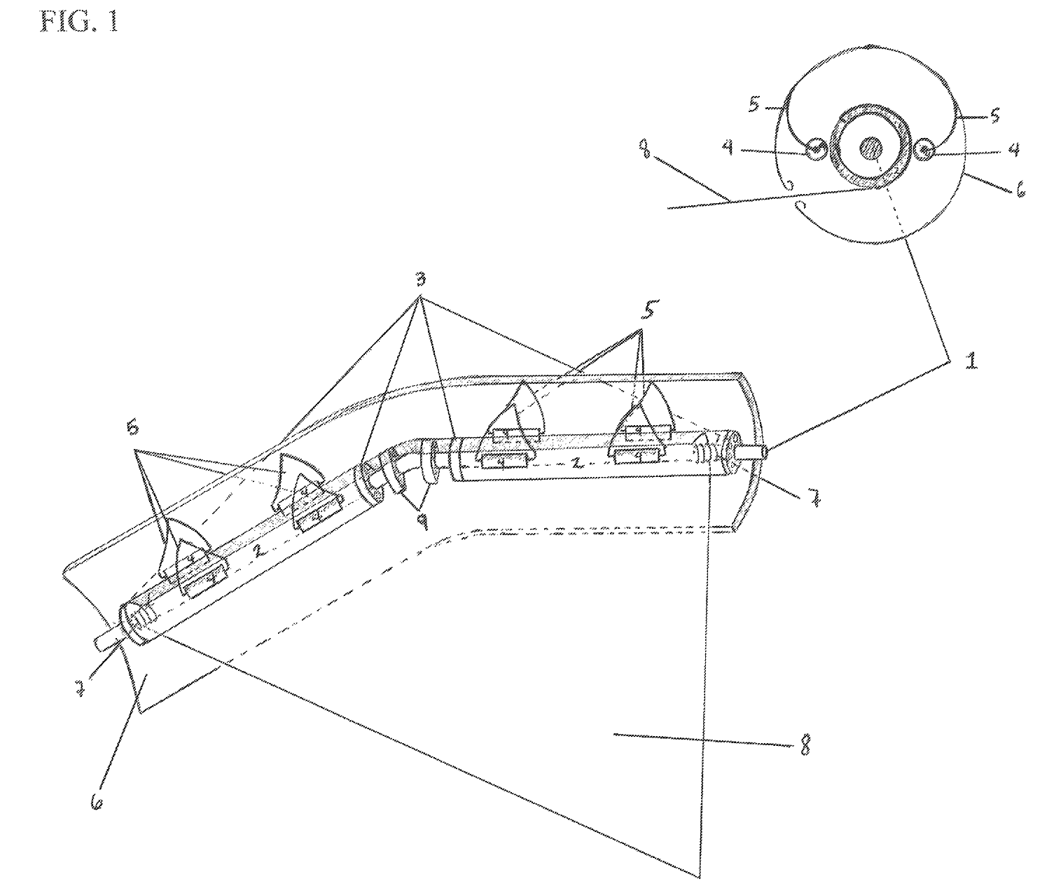

As shown in FIG. 1, a cylindrical housing structure 6, surrounds the retracting mechanism inside. Along this cylindrical housing structure there is a fixed, or non rotating, axel 1, over which rotate at least two other smaller cylinders 2 by means of at least four bearing 3. This figure also shows the inner edge of the canvas roof 8, embedded in the body of these smaller rotating cylinders 2, also seen in the lateral view to the upper right. Inside and to the outer ends of the smaller rotating cylinders 2 there are torsion springs 7, one end of which is attached to the fixed axel 1 and the other to the inner aspect of the smaller rotating cylinders 2.

In FIG. 1, there are also at least eight rollers 4, which will rotate over small axels in turn attached to plates 5, with elastic recoil properties. These plates 5 are partially attached to the inner aspect of the housing structure 6. The outer surface of these rollers 4 will make contact with the outer surface of the smaller rotating cylinders 2 as to stabilize the retracting mechanism while it is being pulled outward by the canvas roof dragged in turn by the opening automobile's door. Lastly in between the smaller rotating cylinders 2 over the vent portion of the fixed axel 1 there could be a plurality of free rotating rings 9, two of which are represented. These rings will support the canvas roof while it is rolled in by the retracting mechanism. The smaller rotating cylinders 2 will accomplish this function in the straight portions of the fixed axel 1.

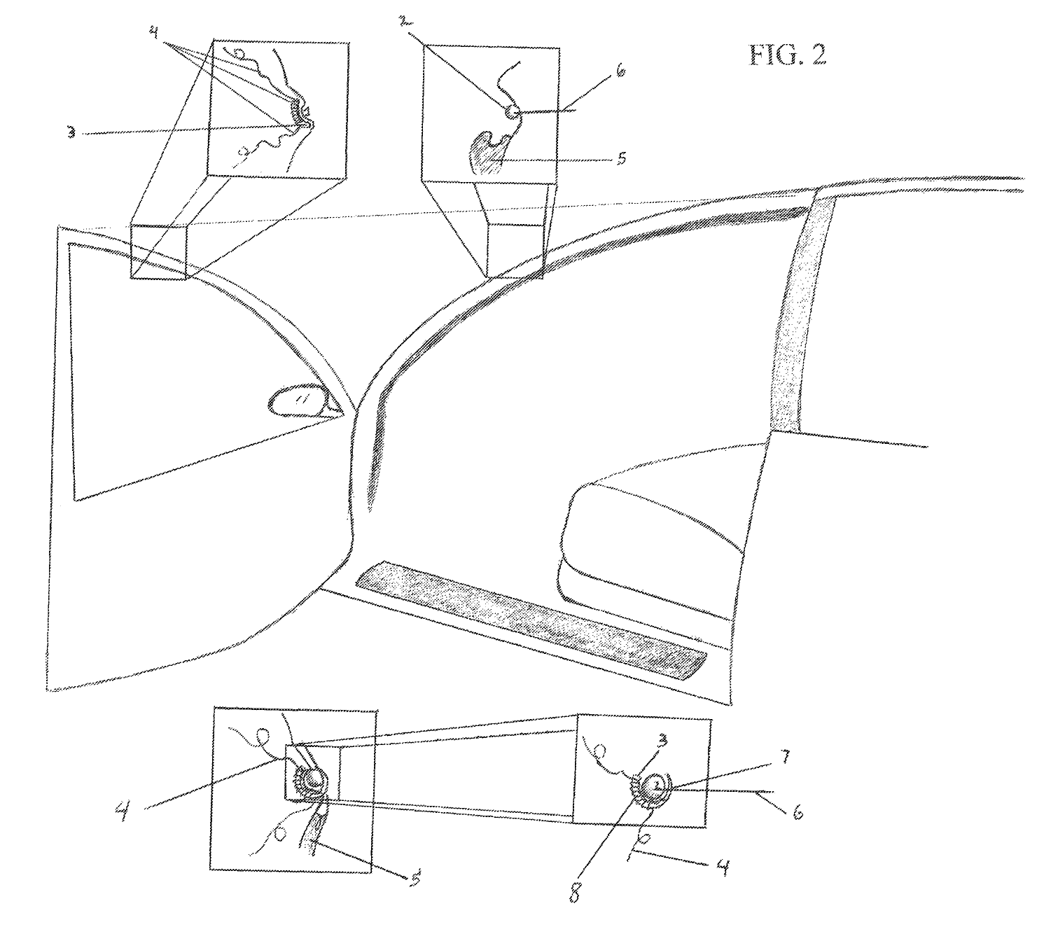

As shown in FIG. 2, there are detail views of the locking mechanism, to the upper left in which 1 represents an indentation along the inner aspect of the door, right inside of this indentation 1 there is a plurality of curved and cylindrical housing structures 3 for the curved latches 7, there is also a representation of an electrical conductor 4 winded around the previously described curved cylindrical structures 3 as to create electromagnets.

As shown in FIG. 2, to the upper right the detail view represents a rod 2 attached to the outer edge of the retractable canvas roof 6, this detail view also depicts the robber lining of the car 5. To the lower left there is another detail view this time of the locking mechanism up against the main body of the car. To the lower right the detail view shows the curved latch 7 deployed behind the rod 2 and again the electrical conductor 4 winded around the curved cylindrical housing structure 3.

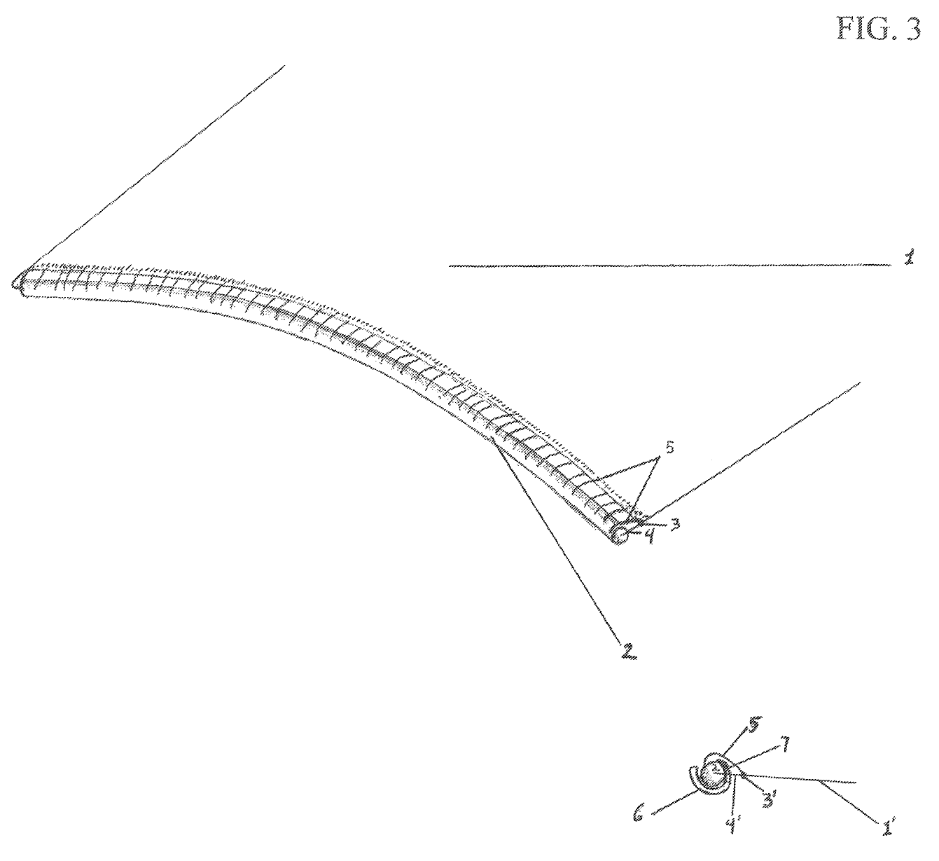

As shown in FIG. 3, there is a rod 2 at the outermost edge of the canvas roof 1. A thick wire 3 loops around the outer edge of the canvas and the rod 2, observe the outer edge of the canvas roof 1 is stitched around this thick wire 3. A band of springy material 5 that spans over the outer edge of the canvas roof 1 is also represented. Please observe that the inner aspect of this band arises from the top of the canvas roof 1 stitched to the thick wire 3 and curves to the front of the rod 2.

This springy material creates a space for the curved latches of the locking mechanism to slide behind the rod without touching the canvas roof which could accelerate wear and tear and at the same time continue to block the rain.

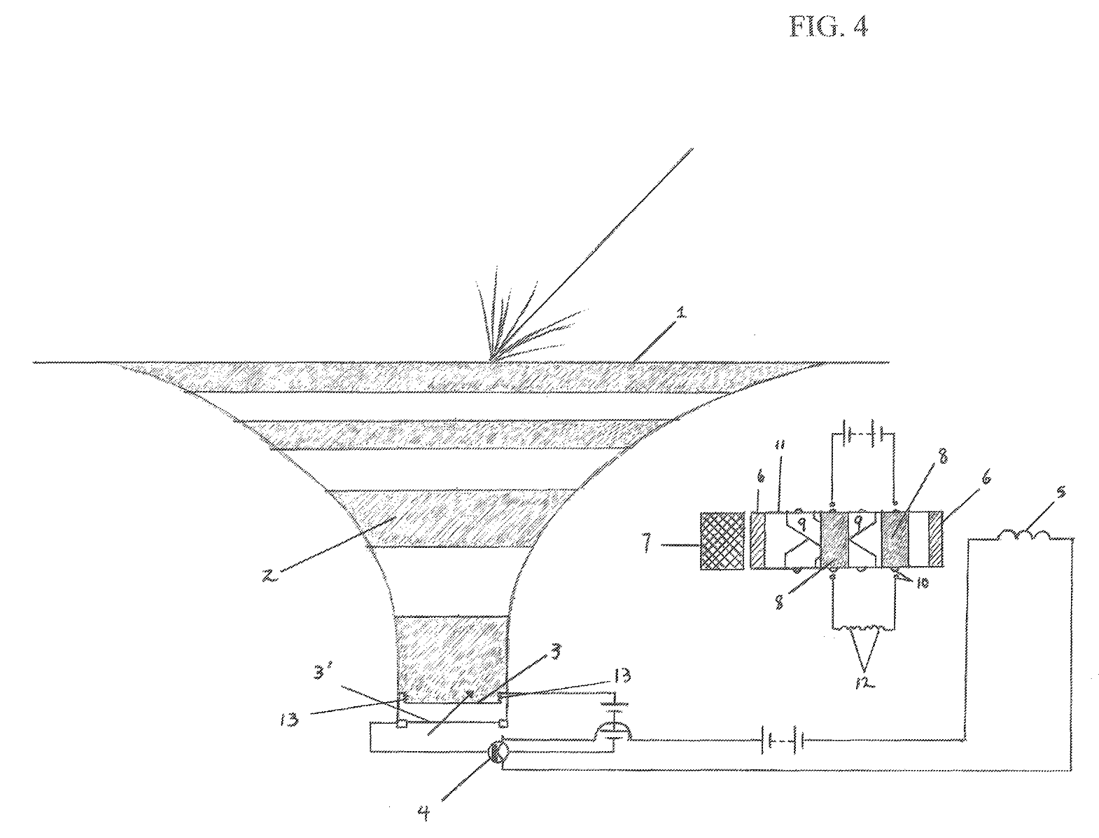

As shown in FIG. 4 There is the conventional roof of the car 1 being hit by a drop of heavy rain. An inverted bell-like structure 2 concentrates the sound waves created by the rain. The mobile plate of variable capacitors 3 is attached to two accordion-like structures 13 that oscillate up and down with the vibrations of the air. 3′ represents the fixed plate of the variable capacitor. This variable capacitor 3 is part of a circuit powered by a battery. A transistor 4 opens or closes the flow of electricity in another circuit depending on the electrical input of the electrical circuit previously mentioned, hence working as a gate. An electromagnet 5 is also part of the second circuit.

As shown also in FIG. 4 This electromagnet 5 will pull on the ferromagnetic plate 6 if there is electricity flowing through the circuit. The ferromagnetic plates 6 are attached to both ends of the sliding contacts plate 11. This sliding contacts plate 11 should be made of a non-conducting material. Embedded in this sliding contacts plate 11 there are two paths for electricity 8 and 9 made of conductive material. Please observe that the net effect of these paths is to invert the direction of the flow of electricity in the circuit that feeds the plurality of electromagnets 12 in the locking mechanism.

As shown in FIG. 4, A permanent magnet 7 intrinsically weaker than the active electromagnet 5 will attract one of the ferromagnetic plates and keep the sliding contacts plate favoring the path of electricity which will in turn keep the curved latches of the locking mechanism housed. Several contacts 10 connect the sliding contacts plate with the circuit which includes the plurality of electromagnets for the locking mechanism.

### DETAILED DESCRIPTION OF INVENTION WORKINGS

The conventional roof of the car FIG. 4 numeral 1, will vibrate under the influence of heavy rain falling. These vibrations will get transmitted and concentrated by the air inside the bell-like structure FIG. 4 numeral 2. The air in turn will make the mobile plate of the variable capacitor FIG. 4 numeral 3, move up and down. These will get the mobile plate of the variable capacitor alternatively closer to and further away from the fixed plate of the variable capacitor FIG. 4 numeral 3′ hence increasing and decreasing the capacitance of the circuit.

This will allow the flow of electricity in the circuit. As represented in FIG. 4 this circuit passes through a transistor FIG. 4, numeral 4, which acts as a gate allowing passage of electricity in a second circuit only if there is electricity from the first circuit passing through it, in this event the electromagnet FIG. 4 numeral 5 will activate and pull on the sliding contact plate, this in turn will favor the passage of electricity in a direction which will cause the electromagnets FIG. 4 numeral 12 and FIG. 2 numeral 8, in the locking mechanism to deploy the curved latches FIG. 2 numeral 7, behind the rod FIG. 2 numeral 2 at the edge of canvas roof. FIG. 2 numeral 6.

The driver opens the door and the door will deploy the canvas roof with it, this in turn will distort the torsion springs FIG. 1 numeral 7 in the retracting mechanism. When the door is closed the torsion springs make the smaller cylinders FIG. 1 numeral 2 rotate over the fixed axel FIG. 1 numeral 1, since the inner edge of the canvas roof FIG. 1 numeral 8, is embedded in the body of these smaller cylinders FIG. 1 numeral 2, the canvas will be rolled onto the small cylinders FIG. 1 numeral 2.

The lack of rain will silence the roof FIG. 4 numeral 1, the mobile plate of the variable capacitor FIG. 4 numeral 3, will not move, the capacitance will not change; no electricity will flow in the first circuit or the second circuit since the transistor FIG. 4 numeral 4, without power from the first circuit will impede flow of electricity in the second circuit, the electromagnet FIG. 4 numeral 5 will be inactive and the sliding contacts plate FIG. 4 numeral 11, will be pulled by the permanent magnet FIG. 4 numeral 7, this in turn will mean flow of electricity in the usual direction FIG. 4 numeral 8, which will again house the curved latches FIG. 2 numeral 7 and disengage the retractable car umbrella.

### NOTES

The distance from the main body of the car to the opened door will be longer from the edge of the door to the body of the car than the distance from the part of the door closest to the hinge to the body of the car. This difference in distances with the door completely opened could be matched with proportional differences in the dimensions of the canvas roof. Ignoring this might cause wrinkles in the canvas roof which in turn could interfere with a proper functioning of the invention.

1. A retractable canvas roof for automobiles, meant to provide cover from heavy rain while getting in an out of said automobile.

2. The system of claim 1 further comprising a mechanism to retract canvas roof while the automobile door is being closed.

3. The system of claim 2 further comprising a rod attached to the canvas roof edge and a locking mechanism embedded in the automobile's door.

4. The system of claim 3 further comprising a sensor meant to detect heavy rain and to engage the locking mechanism as to allow the automobile's opening door to pull on and deploy the canvas roof hence extending it from the main body of the automobile to the opened door.

5. The system of claim 4 further comprising an inverted bell-like structure to focus sound waves generated by drops of rain falling on the automobile's roof, a variable capacitor connected to a circuit in which there is also a source of voltage—battery—. A transistor in a different circuit which further comprises of an electromagnet.

6. The system of claim 5 further comprising a permanent magnet, a sliding contacts plate made of non conducting material with conducting material embedded inside in a specific fashion as to allow passage of electricity in two different directions. Two ferromagnetic caps at each end of the sliding plate and contacts to connect the circuit powering a plurality of electromagnets around the curved and cylindrical housing structures for curved latches.

7. The system of claim 3 further comprising a plurality of curved and cylindrical housing structures for curved latches meant to deploy when appropriate behind the rod at the edge of canvas roof as to engage the retractable umbrella.

8. The system of claim 2 further comprising a cylindrical structure to house the whole apparatus, a fixed axel that runs along the formerly described structure. At least two more smaller cylindrical structures able to rotate over the fixed axel by means of four sets of bearings, the inner edge of the canvas roof will be embedded in these cylinders. Two torsion springs attached to the fixed axel on one end and the smaller rotating cylinders on the other.

9. The system of claim 8 further comprising at least eight rollers able to rotate against the smaller cylinders previously described providing for stability of the retracting mechanism. These rollers will rotate against axels attached to the cylindrical housing structure by means of metallic plates with elastic recoil properties.
